(19) United States
(12) Patent Application Publication
(10) Pub. No.: US 2018/0170247 A1
(43) Pub. Date: Jun. 21, 2018

(54) LAMP ASSEMBLY WITH GRILLE LIGHTING FUNCTION

(71) Applicant: Toyota Motor Engineering & Manufacturing North America, Inc., Erlanger, KY (US)

(72) Inventor: Francisco A. Ramos, II, Ypsilanti, MI (US)

(73) Assignee: Toyota Motor Engineering & Manufacturing North America, Inc., Erlanger, KY (US)

(21) Appl. No.: 15/421,970

(22) Filed: Feb. 1, 2017

Related U.S. Application Data
(60) Provisional application No. 62/435,871, filed on Dec. 19, 2016.

(51) Int. Cl. B60Q 1/28; F21S 8/10; B60Q 1/00

(52) U.S. Cl. CPC B60Q 1/28; B60Q 1/0076; F21S 48/31; F21S 48/1291

(57) ABSTRACT

A vehicular lamp assembly, a vehicle and a method of providing illumination of a vehicular radiator grille. The assembly includes a housing that includes a main headlamp light source that can selectively direct a beam of light through an outer lens produce a first beam pattern, while a grille light source in conjunction with an optic element can be used to selectively a second beam pattern that is routed through the grille to provide illumination to such grille. The placement of both the main headlamp light source and the grille light source within a common headlamp assembly provides enhanced environmental protection of the light sources while avoiding encroachment into vehicular front end territory that is typically reserved for the grille's traditional air flow and related heat exchange functions.

### CROSS-REFERENCE TO RELATED APPLICATIONS

This application claims benefit to U.S. Provisional Application Ser. No. 62/435,871 filed Dec. 19, 2016.

### TECHNICAL FIELD

The present specification relates generally to improved vehicular lighting assemblies, and more particularly to providing a grille-lighting function from a common lighting assembly.

### BACKGROUND

Vehicular headlamp systems are conventionally mounted to the front or front corners of the automobile and adjacent the grille. A relatively recent trend in vehicular design is to have the headlamp systems be formed as part of a larger—and oftentimes modular—assembly. As such, traditional low-beam and high-beam functionality may be packaged along with turn-signal lamps, daytime running lamps, fog lamps or the like. Unfortunately, the packaging space for accommodating the lamp assembly and its increasingly comprehensive lighting capability has a tendency to encroach on the portion of the vehicle that is traditionally reserved for the grille. This may be undesirable as the grille often needs to be large enough to maximize cooling air flow past the radiator and other engine components that benefit from convective heat transfer. As such, any attempt to further expand the functionality of the lamp assembly in general and the lighting signature in particular has to be balanced against larger vehicular system requirements such as the cooling air needs for the grille.

Another relatively recent trend in vehicular design relates to enhancing the aesthetic appeal of the grille. In such configurations, the grille can take on a pronounced role in overall vehicle forward-end decorative attributes. One particularly noteworthy way for the owner to draw additional attention to a decorative grille is to shine light upon—or have it emanating from—such a grille. The additional space and wiring needed to achieve such enhanced illumination adds to the overall lighting system cost and complexity. Moreover, as mentioned above, this enhanced illumination may exacerbate traditional headlamp assembly packaging challenges in the region in or around the grille.

Accordingly, a need exists for a vehicular lamp assembly that provides a grille lighting function while reducing the complexity associated with such enhanced illumination functionality.

### SUMMARY

In one embodiment, a vehicular lamp assembly (also referred to herein as headlamp assembly) is disclosed. The assembly includes a housing that can be mounted to a vehicle. Within the housing, a main headlamp light source can (upon receipt of suitable electric current from the vehicle) direct a beam of light through an outer lens produce a first beam pattern. In addition, a grille light source is disposed within the housing, while an optic element can be used in conjunction with the grille light source to produce (upon receipt of suitable electric current from the vehicle) a second beam pattern that is routed through the grille to provide illumination to such grille.

In another embodiment, a motor vehicle includes a platform made up of a wheeled chassis defining passenger compartment and an engine compartment the latter of which defines a grille formed in a forward portion thereof. An engine (such as a conventional internal combustion engine (ICE)) is situated within the engine compartment. A guidance apparatus is coupled to the wheeled chassis and the engine in order to provide motive control of the vehicle, while a vehicular lamp assembly includes a housing mounted adjacent the engine compartment such that it is substantially lateral to the grille. A main headlamp light source is disposed within the housing, while an outer lens is signally cooperative with the main headlamp light source to produce (upon receipt of suitable electric current from the vehicle) a first beam pattern that is routed through the outer lens. Likewise, a grille light source is also disposed within the housing, while an optic element that is signally cooperative with the grille light source produces (upon receipt of suitable electric current from the vehicle) a second beam pattern that is routed through the grille to provide illumination to such grille.

In yet another embodiment, a method of providing illumination of a vehicular radiator grille is disclosed. The method includes configuring a vehicle-mounted headlamp housing to include a main headlamp light source and a grille light source disposed therein. In addition, an outer lens is signally cooperative with the main headlamp light source so that upon such illumination, a first beam pattern is routed through the outer lens. Likewise, an optic element is signally cooperative with the grille light source so that upon such illumination, a second beam pattern is routed through the grille. A switch within the vehicle may be used to selectively provide electric current to at least the grille light source.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a notional vehicle in accordance with one or more embodiments shown or described herein;

FIG. 2 depicts a front elevation view of a headlamp assembly in accordance with one or more embodiments shown or described herein;

FIGS. 3A through 3C depict the optic element and the grille light source according to one or more embodiments shown or described herein;

FIG. 4 depicts a rear elevation view of the housing for the headlamp assembly of FIG. 2; and

FIG. 5 depicts a simplified plan view of the placement of the grille light source and optic element in accordance with one or more embodiments shown or described herein.

### DETAILED DESCRIPTION

Embodiments disclosed herein include increase the lighting signature of an automotive vehicle such that the grille may be selectively illuminated without increasing the packaging space of a headlamp assembly. In particular, a lamp assembly according to the present disclosure includes a separate light source to provide selective illumination of a radiator grille while taking advantage of existing packaging space.

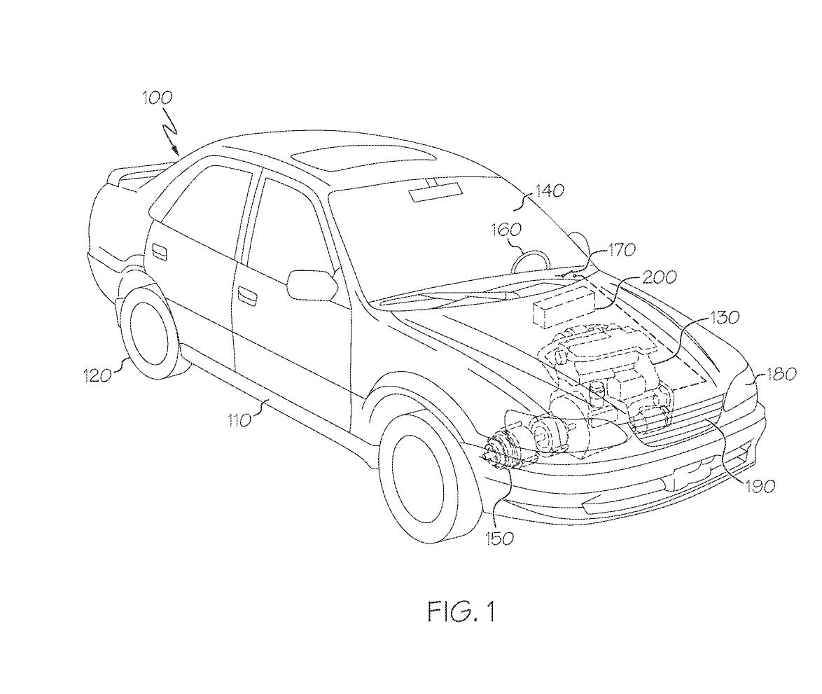

Referring first to FIG. 1, a vehicle 100 includes a chassis 110 with a plurality of wheels 120. Chassis 110 may either be of body-on-frame or unibody construction, and both configurations are deemed to be within the scope of the present disclosure. A motive power unit 130 such as a conventional internal combustion engine (ICE), battery pack, fuel cell stack or a hybrid combination of one or more of the above may be situated in or on the chassis 110 to provide propulsive power to the vehicle 100. As shown, the motive power unit 130 is situated underneath a hood that is placed at the fore end of vehicle 100. A passenger compartment 140 is formed inside the chassis 110 and serves not only as a place to transport passengers and cargo, but also as a place from which a driver may operate vehicle 100. A transmission 150 is coupled to the motive power unit 130 such that together they form a drivetrain through which a torque may be applied to some or all of the wheels 120. A guidance apparatus (which may include, among other things, steering wheel, accelerator, brakes or the like) 160 is used in cooperation with the wheels 120, motive power unit 130, transmission 150 and other systems to control movement of the vehicle 100.

In a preferred configuration, numerous lights are placed around the exterior of vehicle 100. In one form, such lights may be enclosed in a transparently-covered housing that forms part of larger assemblies including left-and-right tail light assemblies (not shown) and left-and-right headlamp assemblies 180 the latter of which are disposed on opposing lateral sides of a grille 190. In one form, the grille 190 is disposed forward of a radiator (not shown) that acts as a heat exchanger for a coolant (such as a mixture of water and ethylene glycol) that is used in conjunction with cooling conduit, valves and pumps to remove excess heat that is generated by the operation of the motive power unit 130. The grille 190 is constructed to provide aesthetic appeal of the vehicle 100 front end while also ensuring that the radiator is exposed to an adequate supply of incoming air, especially when vehicle 100 is moving in a forward direction. In one particular form of construction as shown, the grille 190 includes numerous horizontal ribs or slats that are connected to one another through orthogonally-oriented bracket-like connectors, through a frame-like member that defines the grille 190 periphery, or both. Each rib is vertically spaced apart from its adjacent neighbor so that an air gap is defined between two adjacent ribs. It will be appreciated that other grille 190 shapes, such as differing orientations of the ribs, as well as the use of other shapes besides the generally rectangular ribs, may be employed in the grille 190, and that all such variants are deemed to be within the scope of the present disclosure.

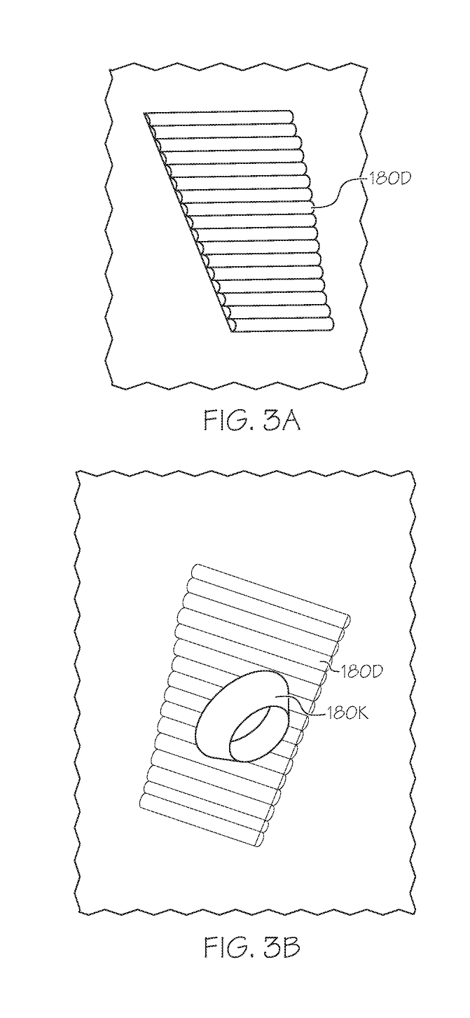

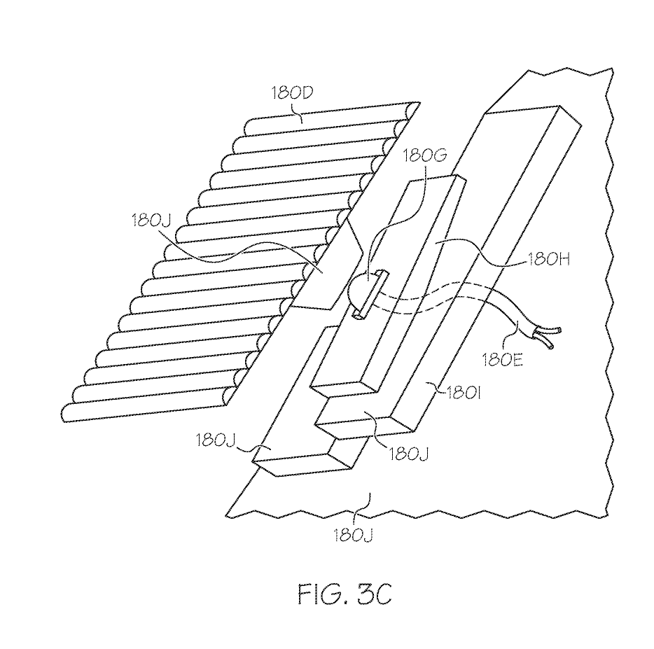

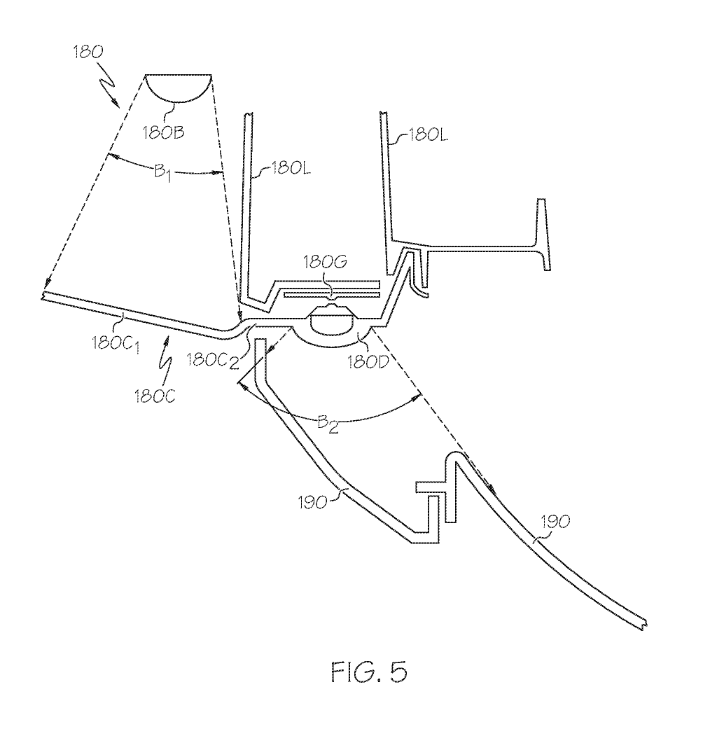

Control of electrical signals to or from the headlamp assemblies 180, as well as to and from various other electrical-based components and systems of vehicle 100, may be provided by one or more electronic control units 200. In one form, the electronic control unit (ECU, also referred to herein as a controller) 200 is operable to receive a command from the driver to actuate the various lights, including turn-signal lamps, daytime running lamps and fog lamps, as well as the lights used in the headlamp assembly 180. The command made given by an input disposed within the vehicle passenger compartment 140, (such as a headlamp switch 170) or by actuation of a remote key. In one form, the ECU 200 may be operable to actuate the grille light source 180G that will be discussed in more detail below in conjunction with FIGS. 3C and 5 so as to shine light on the grille when a command from a wireless key (such as a key fob or the like) is issued to unlock the vehicle 100. In another embodiment, the grille light source 180G may be actuated when the daytime running lights are turned on so as to increase the visibility of the vehicle 100. In yet another embodiment, the grille light source 180G may be turned on and off so as to be integrated with the turn signals of the vehicle 100 so as to provide improved forward-end illumination.

Although shown notionally as being within the passenger compartment 140 or the engine compartment, it will be appreciated that the ECU 200 is situated in any suitable location within vehicle 100 where access to wiring, harnesses or busses is readily available. In addition, it will be appreciated that ECU 200 may be one of many such control units within the vehicle 100, depending on the desired degree of integration or autonomy among such control units. ECU 200 is provided with one or more input/output (I/O) 210, microprocessor (CPU) 220, read-only memory (ROM) 230, random-access memory (RAM) 240, which are respectively connected by a bus to provide connectivity for a logic circuit 250 for the receipt of signal-based data, as well as the sending of commands or related instructions. Various algorithms and related control logic may be stored in the ROM 230 or RAM 240 in manners known to those skilled in the art. Thus, in one form, CPU 220 can be made to operate on the headlamp assembly 180 control logic such that individually and together the various components making up ECU 200 define the logic circuit 250 needed to provide the various forms of main or grille lighting functions as discussed herein. The control logic may be embodied in an algorithm or related program code that can be manipulated or otherwise operated on by CPU 220 and then conveyed via I/O ports 210 to the wiring 180E that delivers electric current to the main headlamp light source 180B and the grille light source 180G. In one form of I/O 210, signals from the switch 170 are input to ECU 200. Other such signals, such as an ignition signal (not shown) that indicates whether or not the engine or related motive power unit 130 is operational may also be signally provided to ECU 200 for suitable processing by the control logic, as can radio-frequency or related signals sent from a driver's key fob.

Within the passenger compartment 140, numerous dials, switches, buttons and other control elements are placed at the driver's disposal in order to selectively operate other vehicular systems; one such control element is in the form of the headlamp switch 170 that is mounted to the instrument panel or dashboard. As will be described in more detail below, such switch 170 is coupled to a battery, alternator or other power source (not shown) in order to provide the electric current needed to power the headlamps 180. The switch 170 may be structured to provide various forms of illumination by the grille light source 180G and the optic element 180D; such forms may include providing illumination upon activation of the main headlamp light source 180B, upon activation of a daytime running lamp (not shown), upon activation of a turn signal (not shown), and in situations independent of any other lighting on the vehicle 100. Two common forms of headlamp systems are reflector-based systems and projector-based systems, where the former includes a filament-based source, a parabolic reflector and a generally planar lens, while the latter includes a light source (for example, based on a filament, arc discharge or the like), an elliptical reflector and axially-spaced convex (i.e., condenser) lens and a movable shield disposed near a beam focal point that converges axially between the reflector and the lens as a way to provide enhanced beam shaping. Either configuration is designed to gather and shape the light being emitted by the source in order to project the beam ahead of the vehicle in compliance with increasingly stringent regulatory standards. Both the reflector and projector versions may also include an optional transparent cover or fairing that protects the parts while also providing enhanced visual appeal. Within the present context, both of the reflector-based and projector-based configurations are deemed to be within the scope of the present disclosure.

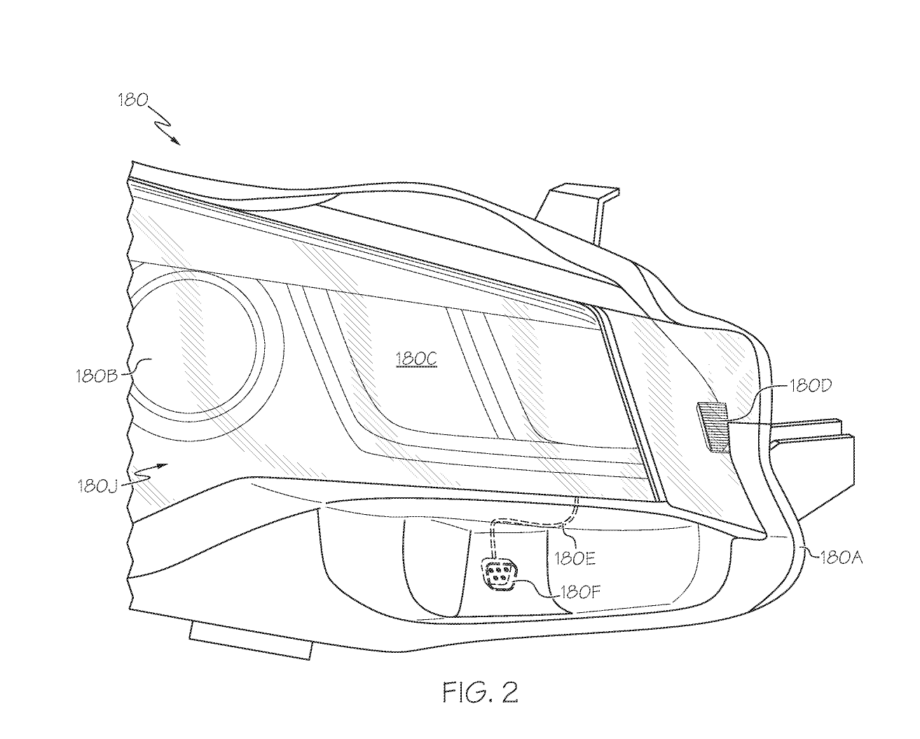

Referring next to FIG. 2, details of one of the headlamp assemblies 180 according to the present disclosure is shown. Although shown presently as the passenger-side headlamp assembly 180, it will be appreciated that the features discussed herein are also applicable to the driver-side headlamp assembly 180 where the components are essentially mirror-images of the ones shown. The lamp assembly 180 includes a housing 180A, a main headlamp light source 180B, an outer lens 180C, an optic element 180D, electrical wiring 180E and an electrical connector 180F, the last shown presently as a five-pin connector but equally applicable to eight-pin or other variants. As will be shown in more detail below, a grille light source 180G is situated behind the optic element 180D such that together they provide illumination of the grille 190. Together, the housing 180A and the outer lens 180C form an enclosure for the main headlamp light source 180B, optic element 180D, electrical wiring 180E, electrical connector 180F and grille lighting source 180G, as well as for other components that will be discussed in more detail below. In one form, the electrical wiring 180E may be part of a larger wiring harness that supplies electrical current to both the main headlamp light source 180B and the grille light source 180G, while in another as dedicated wiring for the grille light source 180G.

In one form, the housing 180A is made from a molded plastic material, and includes one or more of brackets, tabs, apertures or related connection apparatus to facilitate the joining of the headlamp assembly 180 to frames or related vehicular support structure (none of which are shown). In one form, the forward-facing surface 180J of the housing 180A may be coated with or otherwise formed from material such as metalized plastic or the like that is highly-reflective in the visible (i.e., 400 nanometer to 700 nanometer) spectrum. In addition, such surface 180J may be either faceted, parabolic, elliptical or other suitable shape in order to facilitate the preferred directional projection of a beam B₁ (also referred to herein as a first beam pattern) being generated by the main headlamp light source 180B. The outer lens 180C acts as a transparent or translucent covering to help not only provide an aerodynamic fairing for the front end of vehicle 100, but also to provide environmental protection and isolation to the remainder of the components that make up the headlamp assembly 180. In one form, the outer lens 180C may be made from a moldable plastic-based material that is optically transparent in the visible spectrum; examples of such material may include an injection-molded polycarbonate-based material that may optionally have suitable scratch-resistant and anti-ultraviolet degradation additives or coatings. In another form, the outer lens 180C may be made from glass. As will be discussed in more detail below in conjunction with FIG. 5, the outer lens 180C includes various portions—including a main portion 180C₁ and an extension portion 180C₂ that are each configured to optically couple to a corresponding light source such as the main headlamp light source 180B and the grille light source 180G.

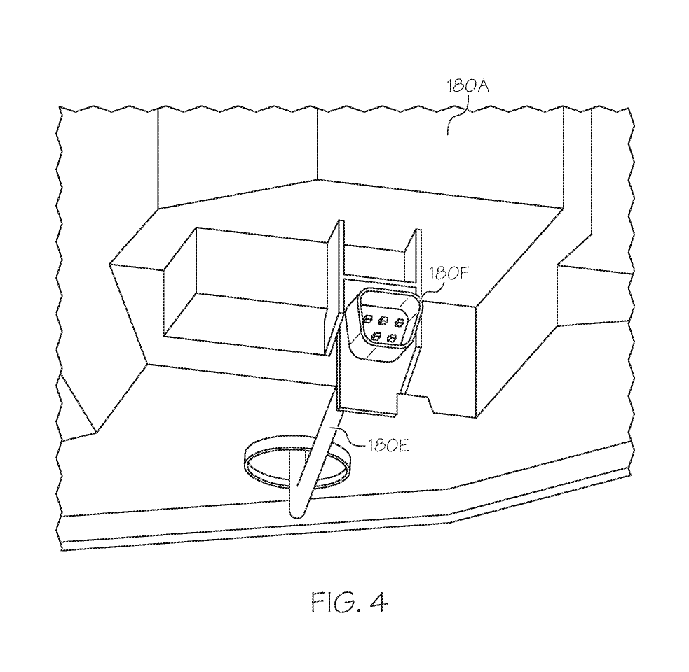

Referring next to FIG. 4, the rear view shows how electrical connectors such as the five-pin connector 180F may be mounted. Because such a connector 180F may already be used to provide other wiring (such as that associated with the main headlamp light source 180B), the wiring 180E that is used to provide electric current to the grille light source 180G can be easily accommodated without having to provide a separate harness. Moreover, the quick-connect nature of the connector 180F is consistent with the modular construction of the headlamp assembly 180.

In one form, the main headlamp light source 180B is formed from a single filament, and may be an incandescent filament including those that are halogen-based; such a configuration may make up a reflector-based headlamp. In another form, the main headlamp light source 180B is formed from a filament that is part of an arc-discharge source that may also include projector-based components. In yet another form, the main headlamp light source 180B is formed from one or more light-emitting diodes (LEDs). All of these aforementioned forms are deemed to be within the scope of the present disclosure.

Referring next to FIGS. 3A through 3C, details of both the optic element 180D and the grille light source 180G are shown, along with other components used to mount the grille light source 180G to a forward-facing surface 180J that is formed on the housing 180A. Referring first with particularity to FIG. 3A, a front perspective view shows one embodiment of the optic element 180D in isolation. As shown, the optic element 180D is made from an optically-transparent or translucent material such as glass, polycarbonate or the like. In addition, it is shaped as a repeating series of elongate, semi-circular prisms in order to direct the generated beam B₂ (as discussed in conjunction with FIG. 5) in a preferred pattern towards and through the grille 190. The prism-like structure and adjacent discontinuities allows the optic element 180D to function as a Fresnel lens or an optical wave guide, the latter particularly if the index of refraction between one or more of the semi-circular prisms is varied in manners known to those skilled in the art.

Referring with particularity to FIG. 3B, the rearward-facing portion of the optic element 180D may have a funnel-like light tube (also called light pipe) 180K that helps to the direct light beam B₂ that emanates from the grille light source 180G to the optic element 180D. Such construction of the light tube 180K can be used to mimic the effects of the optic wave guide in that by suitable choice of angle, reflective coating or the like, the light tube 180K can be used to transport the light being generated at the grille light source 180G to the optic element 180D and other points forward.

Referring with particularity to FIG. 3C, the light tube 180K is shown coupled directly onto the rear surface of the optic element 180D, while both are disposed within the housing 180A so as to protect them from the ambient environment. The grille light source 180G (shown presently as a hemispherical-shaped device, but equally applicable irrespective of the shape) is connected via wiring 180E to a suitable source (not shown) of electric current. The size, shape and relative placement of the grille light source 180G is such that most (if not all) of the light generated thereby is directed toward the rear of the optic element 180D through the conical light tube 180K for subsequent formation into beam B₂. In one form, the grille light source 180G is an LED, and can be formed as part of a light board 180H that may include suitable circuitry inside. Both may in turn be mounted to a lamp bezel 1801 or other similar structure that may make up a portion of the forward-facing surface 180J that is formed on the housing 180A. In another form (not shown), the grille light source 180G is mounted to either the light tube 180K or directly to a structural portion of the outer lens 180C. As shown, the portion of the forward-facing surface 180J that is formed on the housing 180A may be made of numerous faceted portions that may define a stacked relationship for ease of maintenance or replacement in the event the grille light source 180G needs servicing. Furthermore, the use of the housing 180A in conjunction with the outer lens 180C as a way to package the grille light source 180G (in addition to the main headlamp light source 180B) promotes additional environmental sealing that is particularly beneficial in situations where such light sources employ one or more LEDs as the means for illumination, as LED-based devices are particularly susceptible to extremes in temperature, moisture and other environmental factors to which vehicle 100 may be exposed. This is valuable in that such construction would be difficult to implement in a grille-lighting configuration where the light sources are formed in the grille, as the enhanced environmental protection enabled by such packaging has a tendency to encroach on the traditional function of the grille to provide adequate air flow to a radiator or other heat exchange device within vehicle 100.

Referring next to FIG. 5 in conjunction with FIG. 2, the outer lens 180C that covers the main headlamp light source 180A also functions as a structural support wall for the grille light source 180G. The outer lens 180C is signally cooperative with the main headlamp light source 180B to produce a first beam pattern B₁ that is routed through the outer lens 180C; while the grille light source 180G is disposed within the housing 180A. The optic element is signally cooperative with the grille light source 180G to produce a second beam pattern B₂ that is routed through the grille 190 to provide illumination thereof. The main portion 180C₁ is disposed forward of the main headlamp light source 180B in order to help focus, collimate or otherwise direct the first beam pattern B₁ that is generated at the main headlamp light source 180B. In this way, the first beam pattern B₁ may be used to provide illumination of the location forward of the vehicle 100; such forward location may include a portion of a roadway on which the vehicle 100 is traversing. Likewise, the extension portion 180C₂ that is disposed axially behind the grille 190 is positioned so that neither the extension portion 180C₂ nor the grille light source 180G are viewable by an observer from the forward end of vehicle 100. As mentioned above, the extension portion 180C₂ of the contiguous structure that corresponds to the optic element 180D may have the optic element 180D integrally formed therein; this embodiment is depicted in FIG. 5. In another form (not presently shown, but discussed in conjunction with FIG. 3C), the optic element 180D is mounted to a surface of the outer lens 180C in such a way that the optical transmission properties of optic element 180D are preserved. For example, an adhesive could be used, as could a picture frame-like mounting, either so long as the light beam B₂ that is produced by the grille light source 180G is substantially not impacted by the presence of such adhesive or mounting structure. Furthermore, as shown, a separate dome-like isolation may be formed around the optic element 180D in order to form additional environmental protection. Even in the event that the grille light source 180G is made from one or more high-intensity discharge filaments, the degree of autonomy and modularity made possible by the packaging of the headlamp assembly 180 improves installation and overall integration between the assembly 180 and the vehicle 100.

As can be seen with particularity in FIG. 5, the housing 180A includes various support walls 180L that form structure to provide segmentation between the main headlamp light source 180B and the grille light source 180G. Such segmentation may be used to keep substantial optical isolation between the first beam pattern B₁ that is generated at the main headlamp light source 180B and the second beam pattern B₂ that is generated at the grille light source 180G. As can be seen, the outer lens 180C and its main and extension portions 180C₁ and 180C₂ are placed relative to the support walls 180L such that the first beam pattern B₁ that is routed through the respective portion of the contiguous structure of the outer lens 180C is routed substantially entirely through the outer lens 180C in such a way that it avoids passing through the grille 190 from behind, while the second beam pattern B₂ that is routed through the portion of the outer lens 180 that corresponds to the optic element 180D is routed substantially entirely through the grille 190. In situations where the extension portion 180C₂ is used to integrally form the optic element 180D therein, various angled surfaces (such as through molding, prism cutting or the like) may be used, as is understood in the art.

In one preferable form, the placement of the headlamp assembly 180 relative to the grille 190 is such that the second beam pattern B₂ is routed substantially entirely through the grille 190, while none escapes to alter the illumination provided by the first beam pattern B₁ that is generated at the main headlamp light source 180B. The headlamp assembly 180 of claim 1, wherein the provided illumination is selected from the group consisting of illumination upon activation of the main headlamp, illumination upon activation of a daytime running lamp, illumination upon activation of a turn signal, illumination upon activation of grille light source and illumination independent of any other lighting on the vehicle. Furthermore, the grille 190 is structured such that apertures, slots or related air-passage channels are formed therein. These channels—in addition to facilitating the convective cooling of the motive power unit 130 (for example, when configured as an ICE) and other heat-prone components—are such that when the second beam pattern B₂ casts its light on the back of the grille 190, such lighting may create an aesthetically-pleasing back-lit effect that resembles a corona. By such structure, the headlamp assembly 180 of the present disclosure is such that the first beam pattern B₁ is routed substantially entirely through the portion of the outer lens 180C that is used to project the light emanating from the main headlamp light source 180B, while the second beam pattern B₂ is routed substantially entirely through the portion of the outer lens 180C that is used to project the light emanating from the grille light source 180G. Importantly, by having both the main headlamp light source 180B and the grille light source 180G placed within a common housing 180A and assembly 180, packaging and vehicle-integration issues associated with adding supplemental lighting such as the present grille-illuminating function are avoided or minimized.

The vehicle 100 and its headlamp assembly 180 is such that the housing 180A that forms the bulk of the structure that is mounted adjacent the engine compartment is placed substantially lateral to the grille 190 such that the right headlamp assembly 180, the grille 190 and the left headlamp assembly 180 occupy a substantial majority (or even entirety) of the width of the front end of the vehicle 100. Within the present context, such a lateral relationship may also include configurations where the headlamp assemblies 180 are also mounted slightly behind the grille 190. Significantly, the construction of the headlamp assembly 180 is such that the housing 180A is not mounted to the grille 190. In this way, the headlamp assembly 180 does not encroach on so-called “real estate” of grille 190. Such a configuration may be particularly beneficial in situations where the grille 190 is an interchangeable modular assembly designed to fit into a front cavity in different vehicles within a manufacturer's model- or product-line, thereby promoting enhanced compatibility, reduced engineering and manufacturing expenses associated with maintaining a large number of disparate grille shapes, sizes and configurations.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicular lamp assembly comprising:
a housing adapted to be mounted to a vehicle;
a main headlamp light source disposed within the housing;
an outer lens signally cooperative with the main headlamp light source to produce a first beam pattern that is routed through the outer lens;
a grille light source disposed within the housing; and
an optic element signally cooperative with the grille light source to produce a second beam pattern that is routed through the grille to provide illumination thereof.

2. The lamp assembly of claim 1, wherein the outer lens forms a contiguous structure such that the first beam pattern is routed substantially entirely through a main portion of the contiguous structure on its way to a region forward of a vehicle, while the second beam pattern is routed substantially entirely through an extension portion of the contiguous structure on its way to the grille.

3. The lamp assembly of claim 2, wherein the extension portion of the contiguous structure has the optic element integrally formed therein.

4. The lamp assembly of claim 2, wherein the extension portion of the contiguous structure has the optic element mounted thereto.

5. The lamp assembly of claim 4, wherein the optic element comprises a separate environmental isolation formed therearound.

6. The lamp assembly of claim 1, wherein the second beam pattern is routed substantially entirely through the grille.

7. The lamp assembly of claim 1, wherein the provided illumination is selected from the group consisting of illumination upon activation of the main headlamp, illumination upon activation of a daytime running lamp, illumination upon activation of a turn signal, illumination upon activation of grille light source and illumination independent of any other lighting on the vehicle.

8. The lamp assembly of claim 1, wherein the second beam pattern is routed substantially entirely through the grille.

9. The lamp assembly of claim 1, wherein the optic element is selected from the group consisting of wave guide, light pipe and Fresnel lens.

10. The lamp assembly of claim 1, wherein the grille light source is selected from the group consisting of light-emitting diode and high-intensity discharge filament.

11. The lamp assembly of claim 1, wherein the main headlamp light source comprises at least one filament and at least one reflector.

12. The lamp assembly of claim 1, wherein the main headlamp light source comprises at least one filament and at least one projector.

13. A motor vehicle comprising:
a platform comprising a wheeled chassis defining passenger compartment and an engine compartment forward of the passenger compartment and defining a grille formed in a forward portion thereof, the engine compartment comprising an engine disposed therein,
a guidance apparatus cooperative with the wheeled chassis and the engine in order to provide motive control; and
a vehicular lamp assembly comprising:
a housing mounted adjacent the engine compartment such that it is substantially lateral to the grille;
a main headlamp light source disposed within the housing;
an outer lens signally cooperative with the main headlamp light source to produce a first beam pattern that is routed through the outer lens;
a grille light source disposed within the housing; and
an optic element signally cooperative with the grille light source to produce a second beam pattern that is routed through the grille to provide illumination thereof.

14. The motor vehicle of claim 13, wherein the housing is not mounted to the grille.

15. The motor vehicle of claim 13, wherein the outer lens forms a contiguous structure such that the first beam pattern is routed substantially entirely through a main portion of the contiguous structure on its way to a region forward of a vehicle, while the second beam pattern is routed substantially entirely through an extension portion of the contiguous structure on its way to the grille.

16. A method of providing illumination of a vehicular radiator grille, the method comprising:
configuring a headlamp housing within a vehicle, the housing comprising:
a main headlamp light source disposed therein;
an outer lens signally cooperative with the main headlamp light source so that upon such illumination, a first beam pattern is routed through the outer lens;
a grille light source disposed therein; and
an optic element signally cooperative with the grille light source so that upon such illumination, a second beam pattern that is routed through the grille; and
configuring a switch within the vehicle to selectively provide electric current to at least the grille light source.

17. The method of claim 16, wherein the switch is selected from the group consisting of a switch to provide illumination upon activation of the main headlamp, a switch to provide illumination upon activation of a daytime running lamp, a switch to provide illumination upon activation of a turn signal, a switch to provide illumination upon activation of grille light source and a switch to provide illumination independent of any other lighting on the vehicle.

18. The method of claim 17, wherein the housing comprises a support wall that forms contiguous structure with the outer lens such that upon such illumination, the second beam is routed substantially entirely through the grille.

19. The method of claim 18, wherein the first beam pattern is routed substantially entirely through the outer lens.

20. The method of claim 16, wherein the wherein the grille light source is selected from the group consisting of light-emitting diodes and high-intensity discharge filaments.
